(19) United States
(12) Patent Application Publication
(10) Pub. No.: US 2024/0370289 A1
(43) Pub. Date: Nov. 7, 2024

(54) METHOD, APPARATUS AND SYSTEM FOR MANAGING CONTAINER CLUSTERS AND COMPONENTS, AND STORAGE MEDIUM

(71) Applicant: SUZHOU METABRAIN INTELLIGENT TECHNOLOGY CO., LTD., Suzhou, Jiangsu (CN)

(72) Inventors: Debo ZHANG, Suzhou, Jiangsu (CN); Maoyang LIU, Suzhou, Jiangsu (CN)

(21) Appl. No.: 18/563,856

(22) PCT Filed: Feb. 28, 2022
(86) PCT No.: PCT/CN2022/078440

§ 371 Date: Nov. 22, 2023

(30) Foreign Application Priority Data
Sep. 30, 2021 (CN) 202111156120.7

(51) Int. Cl. G06F 9/455

(52) U.S. Cl. CPC G06F 9/45558; G06F 2009/45591

(57) ABSTRACT

The present disclosure discloses a method for managing container clusters and components, an apparatus, a system and a computer-readable storage medium, wherein the method includes: monitoring component sets, and when a component set that has changed exists, obtaining component-set information and component-set-operation information of the component set that has changed, and adding the component-set information and the component-set-operation information as component-set events into an event queue; monitoring clusters, and when a cluster that has changed exists, obtaining cluster information and cluster-operation information of the cluster that has changed, and adding the cluster information and the cluster-operation information as cluster events into the event queue; and obtaining a current event in the event queue, and according to event information of the current event, operating a target component in a target cluster.

### CROSS-REFERENCE TO RELATED APPLICATION

The present application claims the priority of the Chinese patent application filed on Sep. 30, 2021 before the Chinese Patent Office with the application number of 202111156120.7 and the title of “METHOD, APPARATUS AND SYSTEM FOR MANAGING CONTAINER CLUSTERS AND COMPONENTS, AND STORAGE MEDIUM”, which is incorporated herein in its entirety by reference.

### TECHNICAL FIELD

The present disclosure relates to the technical field of computers and, more particularly, to a method for managing container clusters and components, an apparatus, a system and a computer-readable storage medium.

### BACKGROUND

Managing a plurality of kubernetes (i.e., K8s, which is a popular container managing platform) container clusters and cluster components is the most basic application scene of the platform as a service (PaaS) platform, and currently the management on the container clusters and the cluster components is usually performed artificially and manually. However, when a quantity of the clusters is high, because there may be that the same one component is required to be deployed in a plurality of clusters, there may be a large amount of repeating, tedious and time-consuming work, and by using the conventional management modes, more manpower may be required to be consumed and more time is taken and an efficiency of management is low.

In view of the above, how to provide a method for managing container clusters and components, an apparatus, a system and a computer-readable storage medium that solve the above technical problem has become a problem that a person skilled in the art requires solving.

### SUMMARY

An object of the embodiments of the present disclosure is to provide a method for managing container clusters and components, an apparatus, a system and a computer-readable storage medium, which may realize automatic management on the clusters and the components in usage, the consumption of manpower resource is reduced and the efficiency of management is increased.

In order to solve the above technical problem, an embodiment of the present disclosure provides a method for managing container clusters and components, including:
monitoring component sets, and when a component set that has changed exists, obtaining component-set information and component-set-operation information of the component set that has changed, and adding the component-set information and the component-set-operation information as component-set events into an event queue;
monitoring clusters, and when a cluster that has changed exists, obtaining cluster information and cluster-operation information of the cluster that has changed, and adding the cluster information and the cluster-operation information as cluster events into the event queue; and
obtaining a current event in the event queue, and according to event information of the current event, operating a target component in a target cluster.

In some embodiments, the cluster information includes a cluster label and a cluster-connection credential; and the component-set information includes a cluster-selection condition and a component-configuration information.

In some embodiments, the step of obtaining the current event in the event queue, and according to the event information of the current event, operating the target component in the target cluster includes:
when the current event is a current cluster event, according to current-cluster information in the current cluster event, determining the target cluster and the target component; and
according to current-cluster-operation information in the current cluster event, performing a corresponding operation to the target cluster and the target component; and when the current event is a current-component-set event, according to a
current-component-set information in the current-component-set event, determining the target component and the target cluster; and
according to current-component-set-operation information in the current-component-set event, performing the corresponding operation to the target cluster and the target component.

In some embodiments, the step of, according to the current-cluster information in the current cluster event, determining the target cluster and the target component includes:
comparing a current-cluster label in the current-cluster information with respective cluster labels of the clusters, to determine a cluster whose cluster label is the same as the current-cluster label as the target cluster;
comparing the current-cluster label with the cluster-selection conditions in the component sets, to match out a component set whose cluster-selection condition is consistent with the current-cluster label as a target component set; and
according to the current-cluster-operation information, from components in the target component set. finding out a corresponding target component.

In some embodiments, before the step of comparing the current-cluster label in the current-cluster information with the respective cluster labels of the clusters, the method further includes:
according to the current-cluster-operation information, determining whether a current operation is creating the cluster, and when the current operation is creating the cluster, according to the current-cluster information, creating the cluster, regarding the created cluster as the target cluster, and regarding a component in a component set whose cluster screening condition is consistent with the current-cluster label as the target component; and when the current operation is not creating the cluster, executing the step of comparing the current-cluster label in the current-cluster information with the respective cluster labels of the clusters.

In some embodiments, the step of, according to the current-component-set information in the current-component-set event, determining the target component and the target cluster includes:
according to a current cluster screening condition in the current-component-set information, screening out the target component set from the component sets;
comparing the current cluster screening condition with the cluster labels of the clusters, to match out a cluster whose cluster label is consistent with the current cluster screening condition as the target cluster; and
according to the current-component-set-operation information, from the components in the target cluster, finding out the corresponding target component.

In some embodiments, before the step of, according to the current-cluster-operation information in the current cluster event, performing the corresponding operation to the target cluster and the target component, the method further includes:
obtaining the cluster-connection credential of the target cluster, and according to the cluster-connection credential, establishing a connection to the target cluster.

An embodiment of the present disclosure further provides an apparatus for managing container clusters and components, wherein the apparatus includes:
a first monitoring module configured for monitoring component sets, and when a component set that has changed exists, obtaining component-set information and component-set-operation information of the component set that has changed, and adding the component-set information and the component-set-operation information as component-set events into an event queue;
a second monitoring module configured for monitoring clusters, and when a cluster that has changed exists, obtaining cluster information and cluster-operation information of the cluster that has changed, and adding the cluster information and the cluster-operation information as cluster events into the event queue; and
an operating module configured for obtaining a current event in the event queue, and according to event information of the current event, operating a target component in a target cluster.

An embodiment of the present disclosure further provides a system for managing the container clusters and the components, wherein the system includes:
a memory configured for storing a computer program; and
a processor configured for, when executing the computer program, implementing the steps of the method for managing the container clusters and the components stated above.

An embodiment of the present disclosure further provides a computer-readable storage medium, wherein the computer-readable storage medium stores a computer program, and the computer program, when executed by a processor, implements the steps of the method for managing the container clusters and the components stated above.

The embodiments of the present disclosure provide a method for managing container clusters and components, an apparatus, a system and a computer-readable storage medium, wherein the method includes: monitoring component sets, and when a component set that has changed exists, obtaining component-set information and component-set-operation information of the component set that has changed, and adding the component-set information and the component-set-operation information as component-set events into an event queue; monitoring clusters, and when a cluster that has changed exists, obtaining cluster information and cluster-operation information of the cluster that has changed, and adding the cluster information and the cluster-operation information as cluster events into the event queue; and obtaining a current event in the event queue, and according to event information of the current event, operating a target component in a target cluster.

It may be seen that, in the present disclosure, by monitoring the component sets and the clusters, and when a component set that has changed exists, the component-set information and the component-set-operation information of the component set that has changed are obtained and the component-set events are generated, and when a cluster that has changed exists, the cluster information and the cluster-operation information of the cluster that has changed are obtained and the cluster events are generated; and the component-set events and the cluster events are added into the event queue, by obtaining the current event from the event queue, and according to the event information of the current event, the target component in the target cluster is operated. The present disclosure may realize automatic management on clusters and components, the consumption of manpower resource is reduced and the efficiency of management is increased.

### BRIEF DESCRIPTION OF THE DRAWINGS

In order to more clearly illustrate the technical solutions of the embodiments of the present disclosure, the figures that are required to be used to describe the prior art and the embodiments may be briefly described below. Apparently, the figures that are described below are merely embodiments of the present disclosure, and a person skilled in the art may obtain other figures according to these figures without paying creative work.

FIG. 1 is a schematic flow chart of a method for managing container clusters and components according to an embodiment of the present disclosure;

FIG. 2 is a schematic structural diagram of a component set according to an embodiment of the present disclosure;

FIG. 3 is a schematic structural diagram of an apparatus for managing container clusters and components according to an embodiment of the present disclosure;

FIG. 4 is a schematic structural diagram of a system for managing container clusters and components according to an embodiment of the present disclosure;

FIG. 5 is a schematic diagram of the management time sequence of the managing system in FIG. 4; and

FIG. 6 is a schematic structural diagram of a computer-readable storage medium according to an embodiment of the present disclosure.

### DETAILED DESCRIPTION

The embodiments of the present disclosure provide a method for managing container clusters and components, an apparatus, a system and a computer-readable storage medium, which may realize automatic management on clusters and components in usage, the consumption of manpower resource is reduced and the efficiency of management is increased.

In order to make the objects, the technical solutions and the advantages of the embodiments of the present disclosure clearer, the technical solutions according to the embodiments of the present disclosure may be clearly and completely described below with reference to the drawings according to the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

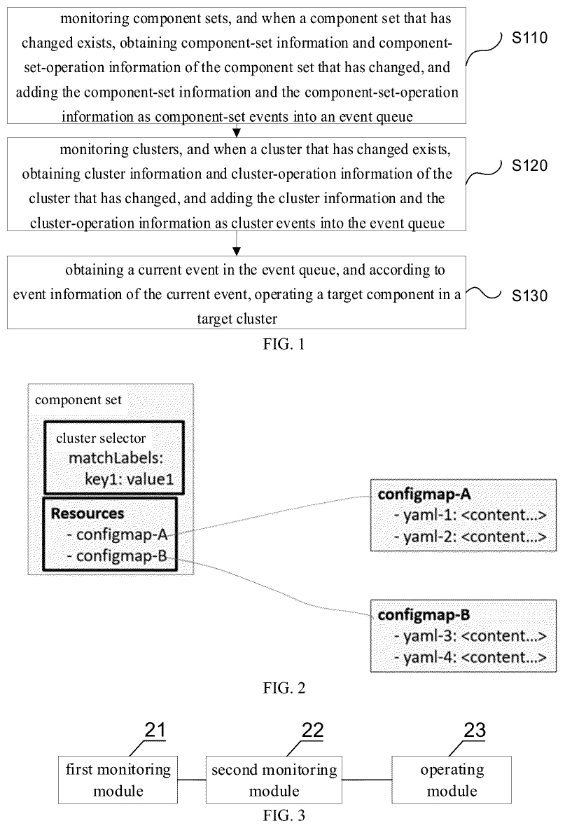

Referring to FIG. 1, FIG. 1 is a schematic flow chart of a method for managing container clusters and components according to an embodiment of the present disclosure. The method includes:

S110: monitoring component sets, and when a component set that has changed exists, obtaining component-set information and component-set-operation information of the component set that has changed, and adding the component-set information and the component-set-operation information as component-set events into an event queue.

It should be noted that the clusters and the components are of a many-to-many relation, wherein one cluster may be installed with a plurality of components, and the same one component may also be installed in a plurality of clusters. Therefore, in the embodiments of the present disclosure, when the components of a mass quantity of kubernetes clusters are managed, the management is performed from the two dimensions, the clusters and the components. Particularly, the management on the clusters and the components may be realized by the management on the component sets and the clusters. When the user is performing an operation to the component sets such as creating, modifying and deleting, the corresponding component sets may change. Therefore, by monitoring the component sets, when a component set that has changed is monitored, the component-set information and the component-set-operation information of the component set that has changed are obtained. Furthermore, the event queue is established in advance, and when the changing is monitored, the component-set events are added into the event queue.

S120: monitoring clusters, and when a cluster that has changed exists, obtaining cluster information and cluster-operation information of the cluster that has changed, and adding the cluster information and the cluster-operation information as cluster events into the event queue.

It should be noted that S110 and S120 in the embodiments of the present disclosure may be executed simultaneously. In other words, simultaneously with the monitoring on the component sets, the clusters may be monitored. When the user performs an operation to the clusters such as creating, modifying and deleting, the corresponding clusters change. Therefore, by monitoring the clusters, when a cluster changes, the cluster information and the cluster-operation information of the cluster that has changed are obtained. Subsequently, based on the cluster information and the cluster-operation information, the cluster events are generated and added into the event queue. In other words, as long as one event (a component-set event or a cluster event) is detected, it is added into the event queue.

S130: obtaining a current event in the event queue, and according to event information of the current event, operating a target component in a target cluster.

In the embodiments of the present disclosure, the current events are continuously obtained from the event queue and processed. By determining whether the event queue is blank. when the event queue is not blank, the current event from the event queue may be obtained and processed; and after the current event is completely processed, the next event is continued to be regarded as the current event and is continued to be processed. When the current event is processed, the event information of the current event may be obtained, according to the event information, the target cluster and the target component that are to be managed are determined, and, subsequently, according to the information in the event information, a management operation to the target cluster and the target component is performed.

Further, the cluster information includes a cluster label and a cluster-connection credential; and the component-set information includes a cluster-selection condition and component-configuration information.

Regarding the clusters, in the embodiments of the present disclosure, in order to realize the management on the clusters, it is required to master the connection credentials (kubeconfig) of all of the clusters. With the connection credentials, after the target cluster is determined, the connection to the target cluster may be established according to the connection credential of the target cluster, and subsequently the target cluster may be operated. The information of a complete connection credential kubeconfig contains the uniform resource locator (URL), the certificate, the user, the token, and so on, of the cluster, and may be a part of text in the format of json or yaml. The connection credential is required to have a sufficiently high permission with respect to the cluster, to ensure that the component may be normally installed, uninstalled and modified. In addition, the cluster information further contains a cluster label label, which is used to identify the cluster, wherein the cluster label may be configured in the form of key-value pairs. and may contain a plurality of key-value pairs to define one label.

In practical applications, each of the clusters may be assigned with one cluster instance. In the cluster instance, the basic information of the cluster is saved, which include the label and the connection credential, and, certainly, may further include the name, the kubernetes edition, the kubeconfig and so on. The cluster instance solves the problem of managing the cluster dimensions.

Regarding the component sets, in the embodiments of the present disclosure, the component-set information includes a cluster-selection condition and component-configuration information. The cluster-selection condition is used to limit the clusters that are suitable for the component set. The component-configuration information is used to determine the components.

In practical applications, by a cluster selector, the cluster-selection condition may be determined, and by the resources, the configuration of the component set may be determined.

The cluster selector is a group of key-value pairs, and is used to specify which clusters the component set is suitable for. For example, in FIG. 2, it is set that matchLabels: key 1=value1, which indicates that all of the clusters that contain the label of key 1=value1 are suitable for that component set; in other words, the components in that component set are created in the clusters that contain the label of key1=value1. Certainly, when matchLabels: key1=value1 and key2=value2 are set in the component set, then all of the clusters that contain both of the two labels of key1=value1 and key 2=value2 are suitable for that component set.

The resources specify the component configurations contained by the component set, wherein the component configurations are saved in a plurality of configmaps, one component set may contain a plurality of configmaps, and each of the configmaps may contain a plurality of yaml/json files. The configmap is one of the kubernetes resources, is used to save multiple file contents, and may be connected to the containers as storage volumes.

Further, the step of obtaining the current event in the event queue, and according to the event information of the current event, operating the target component in the target cluster in the above S130 may include:
when the current event is a current cluster event, according to current-cluster information in the current cluster event, determining the target cluster and the target component; and
according to current-cluster-operation information in the current cluster event, performing a corresponding operation to the target cluster and the target component.

In other words, when an obtained event type of current time is the cluster event, the current event is the current cluster event, the current-cluster information in the current cluster event is obtained, and, subsequently, the corresponding target cluster and target component are determined according to the current-cluster information.

A current-cluster label in the current-cluster information is compared with respective cluster labels of the clusters, to determine a cluster whose cluster label is the same as the current-cluster label as the target cluster.

The current-cluster label is compared with the cluster-selection conditions in the component sets, to match out a component set whose cluster-selection condition is consistent with the current-cluster label as a target component set, wherein when all of the labels contained in the cluster-selection condition of the component set are consistent with the current-cluster label, the corresponding component set is the target component set.

According to the current-cluster-operation information, from components in the target component set, the corresponding target component is found out.

The target component set contains a plurality of components. In order to find out which component is modified by the user, the information may be uniquely labeled according to the component identifiers or the component names and so on, according to the current-cluster-operation information, from each of the components in the target component set, the to-be-operated target component is found out, wherein the current-cluster-operation information may contain the cluster information of the operated cluster, the component information of the components (which may be the IDs, the names and so on of the components), and the operation type (for example, adding, deleting or modifying), and, subsequently, according to current-cluster-operation information in the current cluster event, a corresponding operation to the target cluster and the target component is performed, for example, the operation of installing the component 1 to the cluster 1 is performed.

In other words, in the embodiments of the present disclosure, after it is determined which components are required to be created, deleted or modified in which clusters, an operation list may be formed, and subsequently the corresponding operation may be performed to the target cluster and the target component according to the operation list. Certainly, when the operation list is blank, then it is not required to be executed, and the next event in the event queue may be continued to be processed.

Further, before the step of comparing the current-cluster label in the current-cluster information with the respective cluster labels of the clusters, the method may further include:
according to the current-cluster-operation information, determining whether a current operation is creating a cluster, and when the current operation is creating the cluster, according to the current-cluster information, creating the cluster, regarding the created cluster as the target cluster, and regarding a component in a component set whose cluster screening condition is consistent with the current-cluster label as the target component; and when the current operation is not creating the cluster, executing the step of comparing the current-cluster label in the current-cluster information with the respective cluster labels of the clusters.

In other words, when the current-cluster-operation information is creating the cluster, then it is not an operation to the existing clusters. Therefore, it is required to firstly create a cluster, regard the created cluster as the target cluster, and subsequently match the cluster screening conditions with the current-cluster label, wherein when the cluster screening condition is matched with the current-cluster label, the component set corresponding to the cluster screening condition is the target component set, and the components in the target component set are the target components.

When the current event is a current-component-set event, according to current-component-set information in the current-component-set event, the target component and the target cluster are determined.

According to a current-component-set-operation information in the current-component-set event, a corresponding operation to the target cluster and the target component is performed.

In other words, when the obtained event type of the current time is the component-set event, the current event is the current-component-set event, the current-component-set information in the current-component-set event is obtained, and, subsequently, the corresponding target cluster and target component are determined according to the current-component-set information.

According to a current cluster screening condition in the current-component-set information, the target component set is screened out from the component sets.

Comparing the current cluster screening condition with the cluster labels of the clusters, to match out a cluster whose cluster label is consistent with the current cluster screening condition as the target cluster.

According to the current-cluster-operation information, from the components in the target cluster, the corresponding target component is found out.

Further, before the step of, according to the current-cluster-operation information in the current cluster event, performing the corresponding operation to the target cluster and the target component, the method may further include:
obtaining the cluster-connection credential of the target cluster, and according to the cluster-connection credential, establishing a connection to the target cluster.

In other words, before the operation to the target cluster and the target component, the cluster-connection credential of the target cluster is obtained, a k8s-client is created by using the cluster-connection credential and is connected to the target cluster apiserver, and an operation such as installing, uninstalling and modifying is performed to the target component of the target cluster, to maintain that the actual state of the cluster component is consistent with the desired state, to satisfy the user demands. The principle of its implementation is, firstly, reading a resource list of the target component set, obtaining the resources yaml/json in the relevant configmaps one by one according to the resource list, and creating, deleting or modifying the resources defined in the yaml/json by using k8s-client.

In practical applications, the embodiments of the present disclosure may be, without limitation, applied to the following scenes, to greatly increase the efficiency of management:
installing a certain component for a plurality of clusters: setting a component set, and setting corresponding labels for the target clusters;
collectively modifying the parameter configuration of a certain component; directly modifying the yaml/json in a component set;
collectively uninstalling a certain component: deleting the component set, or deleting the cluster selector in the component set; and
uninstalling a certain component for an individual cluster: removing the corresponding label of the target cluster.

It may be seen that, in the present disclosure, by monitoring the component sets and the clusters, and when a component set that has changed exists, the component-set information and the component-set-operation information of the component set that has changed are obtained and the component-set events are generated, and when a cluster that has changed exists, the cluster information and the cluster-operation information of the cluster that has changed are obtained and the cluster events are generated; and the component-set events and the cluster events are added into the event queue, by obtaining the current event from the event queue, and according to the event information of the current event, the target component in the target cluster is operated. The present disclosure may realize automatic management on clusters and components, the consumption of manpower resource is reduced and the efficiency of management is increased.

On the basis of the above embodiments, an embodiment of the present disclosure further provides an apparatus for managing container clusters and components. Particularly, referring to FIG. 3, the apparatus includes:
a first monitoring module 21 configured for monitoring component sets, and when a component set that has changed exists, obtaining component-set information and component-set-operation information of the component set that has changed, and adding the component-set information and the component-set-operation information as component-set events into an event queue;
a second monitoring module 22 configured for monitoring clusters, and when a cluster that has changed exists, obtaining cluster information and cluster-operation information of the cluster that has changed, and adding the cluster information and the cluster-operation information as cluster events into the event queue; and
an operating module 23 configured for obtaining a current event in the event queue, and according to event information of the current event, operating a target component in a target cluster.

It should be noted that the apparatus for managing the container clusters and the components according to the embodiments of the present disclosure has the advantageous effects the same as those of the method for managing the container clusters and the components according to the above embodiments, and the description on the method for managing the container clusters and the components according to the embodiments of the present disclosure may be referred to the above embodiments, and is not discussed further in the present disclosure.

On the basis of the above embodiments, an embodiment of the present disclosure further provides a system for managing container clusters and components, wherein the system includes:
a memory configured for storing a computer program; and
a processor configured for, when executing the computer program, implementing the steps of the method for managing the container clusters and the components stated above.

For example, the processor according to the embodiment of the present disclosure may be configured to implement monitoring component sets, and when a component set that has changed exists, obtaining component-set information and component-set-operation information of the component set that has changed, and adding the component-set information and the component-set-operation information as component-set events into an event queue; monitoring clusters, and when a cluster that has changed exists, obtaining cluster information and cluster-operation information of the cluster that has changed, and adding the cluster information and the cluster-operation information as cluster events into the event queue; and obtaining a current event in the event queue, and according to event information of the current event, operating a target component in a target cluster.

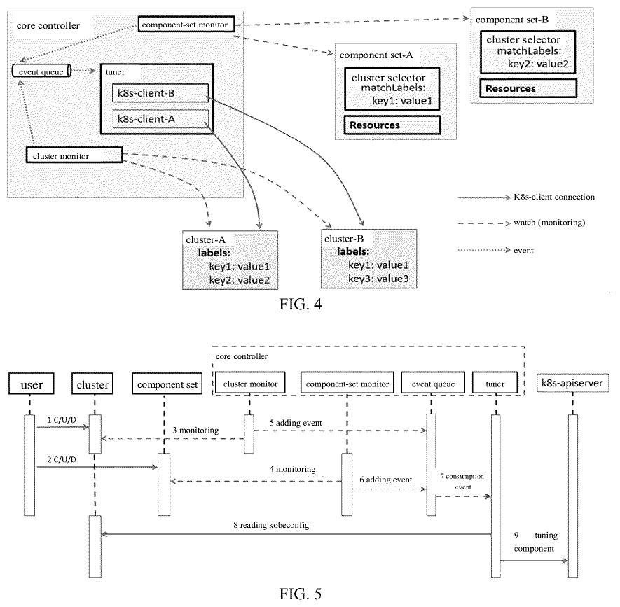

It should be noted that the processor according to the embodiments of the present disclosure may be a core controller, wherein the core controller may include a cluster monitor, a component-set monitor, the event queue and a tuner, which may be referred to FIGS. 4 and 5.

The cluster monitor may be used to monitor the situation of the changing of the clusters, it employs the watch (monitoring) mechanism in the kubernetes core mechanism, and it is based on the chunked transfer encoding of HTTP. The cluster monitor, when invoking the watch application program interface (API) of the resources, establishes a long connection, when the resources have a change such as creation, deletion and modification, the watch API forms data blocks with the changing contents (one time of changing generates one data block), sends to a monitor, generates a cluster event, and adds into the event queue. Each of the resources of all of the types in kubernetes has one corresponding watch API, and what corresponds to it is a list API, and the list API is responsible for listing the full data of that type of resource. Based on an HTTP short connection, the watch API is responsible for feeding back the incremental data of that type of resource. Based on an HTTP long connection, only when the resources have a change (creation, deletion and modification), a data block is sent, wherein the data block contains merely the content of this time of changing.

The component-set monitor may be used to monitor the situation of the changing of the component sets, for example, monitoring the change such as creation, deletion and modification of the component sets, generating a component-set event, and adding into the event queue. The event queue is a first-in first-out queue.

The tuner may be used to read the current event from the event queue, and analyze the current event to determine the target cluster and the target component. Subsequently, a k8s-client is created by using the cluster-connection credential of the target cluster and is connected to the target cluster, to perform an operation such as installing, uninstalling and modifying to the components of the cluster, to maintain that the actual state of the cluster component is consistent with the desired state.

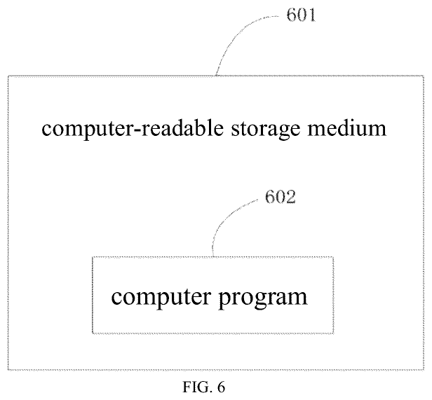

On the basis of the above embodiments, referring to FIG. 1, an embodiment of the present disclosure further provides a computer-readable storage medium. FIG. 6 is a schematic structural diagram of a computer-readable storage medium according to an embodiment of the present disclosure. The computer-readable storage medium 601 stores a computer program 602, and the computer program 602, when executed by a processor, implements the steps of the method for managing the container clusters and the components stated above.

The computer-readable storage medium 601 may include various media that may store a program code, such as a USB flash disk, a mobile hard disk drive, a read-only memory (ROM). a random access memory (RAM), a diskette and an optical disk.

The embodiments of the description are described in the mode of progression, each of the embodiments emphatically describes the differences from the other embodiments, and the same or similar parts of the embodiments may be referred to each other. Regarding the devices according to the embodiments, because they correspond to the methods according to the embodiments, they are described simply, and the relevant parts may be referred to the illustration on the methods.

It should also be noted that, in the specification, relation terms such as first and second are merely intended to distinguish one entity or operation from another entity or operation, and that does not necessarily require or imply that there are any such actual relation or order between those entities or operations. Furthermore, the terms “include”, “comprise” or any variants thereof are intended to cover non-exclusive inclusions, so that processes, methods, articles or devices that include a series of elements do not only include those elements, but also include other elements that are not explicitly listed, or further include the elements that are inherent to such processes, methods, articles or devices. Unless further limitation is set forth, an element defined by the wording “including a . . . ” does not exclude that additional same element further exists in the process, method, article or device including the element.

The above description on the disclosed embodiments enables a person skilled in the art to implement or use the present disclosure. Various modifications on those embodiments will be apparent to a person skilled in the art, and the general principle defined herein may be implemented in other embodiments without departing from the spirit or scope of the present disclosure. Therefore, the present disclosure should not be limited to the embodiments illustrated herein, but should meet the broadest scope in accord with the principle and the novel characteristics disclosed herein.

1. A method for managing container clusters and components, comprising:
monitoring component sets, and when a component set that has changed exists, obtaining component-set information and component-set-operation information of the component set that has changed, and adding the component-set information and the component-set-operation information as component-set events into an event queue;
monitoring clusters, and when a cluster that has changed exists, obtaining cluster information and cluster-operation information of the cluster that has changed, and adding the cluster information and the cluster-operation information as cluster events into the event queue; and
obtaining a current event in the event queue, and according to event information of the current event, operating a target component in a target cluster.

2. The method for managing the container clusters and the components according to claim 1, wherein the cluster information comprises a cluster label and a cluster-connection credential; and the component-set information comprises a cluster-selection condition and component-configuration information.

3. The method for managing the container clusters and the components according to claim 2, wherein the step of obtaining the current event in the event queue, and according to the event information of the current event, operating the target component in the target cluster comprises:
when the current event is a current cluster event, according to current-cluster information in the current cluster event, determining the target cluster and the target component; and
according to current-cluster-operation information in the current cluster event, performing a corresponding operation to the target cluster and the target component;
when the current event is a current-component-set event, according to current-component-set information in the current-component-set event, determining the target component and the target cluster; and
according to current-component-set-operation information in the current-component-set event, performing the corresponding operation to the target cluster and the target component.

4. The method for managing the container clusters and the components according to claim 3, wherein the step of, according to the current-cluster information in the current cluster event, determining the target cluster and the target component comprises:
comparing a current-cluster label in the current-cluster information with respective cluster labels of the clusters, to determine a cluster whose cluster label is the same as the current-cluster label as the target cluster;
comparing the current-cluster label with the cluster-selection conditions in the component sets, to match out a component set whose cluster-selection condition is consistent with the current-cluster label as a target component set; and
according to the current-cluster-operation information, from components in the target component set, finding out a corresponding target component.

5. The method for managing the container clusters and the components according to claim 4, wherein before comparing the current-cluster label in the current-cluster information with the respective cluster labels of the clusters, the method further comprises:
according to the current-cluster-operation information, determining whether a current operation is creating the cluster, and when the current operation is creating the cluster, according to the current-cluster information, creating the cluster, regarding the created cluster as the target cluster, and regarding a component in a component set whose cluster screening condition is consistent with the current-cluster label as the target component; and when the current operation is not creating the cluster, executing the step of comparing the current-cluster label in the current-cluster information with the respective cluster labels of the clusters.

6. The method for managing the container clusters and the components according to claim 3, wherein the step of, according to the current-component-set information in the current-component-set event, determining the target component and the target cluster comprises:
according to a current cluster screening condition in the current-component-set information, screening out the target component set from the component sets;
comparing the current cluster screening condition with the cluster labels of the clusters, to match out a cluster whose cluster label is consistent with the current cluster screening condition as the target cluster; and
according to the current-component-set-operation information, from the components in the target cluster, finding out the corresponding target component.

7. The method for managing the container clusters and the components according to claim 3, wherein before the step of, according to the current-cluster-operation information in the current cluster event, performing the corresponding operation to the target cluster and the target component, the method further comprises:
obtaining the cluster-connection credential of the target cluster, and according to the cluster-connection credential, establishing a connection to the target cluster.

8-10. (canceled)

11. A system for managing the container clusters and the components, comprising:
a memory configured for storing a computer program; and
a processor configured for, when executing the computer program, implementing the steps of the method for managing the container clusters and the components according to claim 1.

12. A non-transitory computer-readable storage medium, wherein the computer-readable storage medium stores a computer program, and the computer program, when executed by a processor, implements the steps of the method for managing the container clusters and the components according to claim 1.

13. The method for managing the container clusters and the components according to claim 1, wherein a relation between the clusters and the components is a many-to-many relation.

14. The method for managing the container clusters and the components according to claim 2, wherein information of the cluster-connection credential comprises a uniform resource locator (URL), a certificate, a user and a token of the cluster.

15. The method for managing the container clusters and the components according to claim 2, wherein the cluster label is configured in a form of key-value pairs.

16. The system for managing the container clusters and the components according to claim 11, wherein the cluster information comprises a cluster label and a cluster-connection credential; and the component-set information comprises a cluster-selection condition and component-configuration information.

17. The system for managing the container clusters and the components according to claim 16, wherein the operation of obtaining the current event in the event queue, and according to the event information of the current event, operating the target component in the target cluster comprises:
when the current event is a current cluster event, according to current-cluster information in the current cluster event, determining the target cluster and the target component; and
according to current-cluster-operation information in the current cluster event, performing a corresponding operation to the target cluster and the target component;
when the current event is a current-component-set event, according to current-component-set information in the current-component-set event, determining the target component and the target cluster; and
according to current-component-set-operation information in the current-component-set event, performing the corresponding operation to the target cluster and the target component.

18. The system for managing the container clusters and the components according to claim 17, wherein the operation of, according to the current-cluster information in the current cluster event, determining the target cluster and the target component comprises:
comparing a current-cluster label in the current-cluster information with respective cluster labels of the clusters, to determine a cluster whose cluster label is the same as the current-cluster label as the target cluster;
comparing the current-cluster label with the cluster-selection conditions in the component sets, to match out a component set whose cluster-selection condition is consistent with the current-cluster label as a target component set; and
according to the current-cluster-operation information, from components in the target component set, finding out a corresponding target component.

19. The system for managing the container clusters and the components according to claim 18, wherein before comparing the current-cluster label in the current-cluster information with the respective cluster labels of the clusters, the method further comprises:
according to the current-cluster-operation information, determining whether a current operation is creating the cluster, and when the current operation is creating the cluster, according to the current-cluster information, creating the cluster, regarding the created cluster as the target cluster, and regarding a component in a component set whose cluster screening condition is consistent with the current-cluster label as the target component; and when the current operation is not creating the cluster, executing the step of comparing the current-cluster label in the current-cluster information with the respective cluster labels of the clusters.

20. The system for managing the container clusters and the components according to claim 17, wherein the operation of, according to the current-component-set information in the current-component-set event, determining the target component and the target cluster comprises:
according to a current cluster screening condition in the current-component-set information, screening out the target component set from the component sets;
comparing the current cluster screening condition with the cluster labels of the clusters, to match out a cluster whose cluster label is consistent with the current cluster screening condition as the target cluster; and
according to the current-component-set-operation information, from the components in the target cluster, finding out the corresponding target component.

21. The system for managing the container clusters and the components according to claim 17, wherein before the operation of, according to the current-cluster-operation information in the current cluster event, performing the corresponding operation to the target cluster and the target component, the method further comprises:
obtaining the cluster-connection credential of the target cluster, and according to the cluster-connection credential, establishing a connection to the target cluster.

22. The non-transitory computer-readable storage medium according to claim 12, wherein the cluster information comprises a cluster label and a cluster-connection credential; and the component-set information comprises a cluster-selection condition and component-configuration information.

23. The non-transitory computer-readable storage medium according to claim 22, wherein the operation of obtaining the current event in the event queue, and according to the event information of the current event, operating the target component in the target cluster comprises:
when the current event is a current cluster event, according to current-cluster information in the current cluster event, determining the target cluster and the target component; and
according to current-cluster-operation information in the current cluster event, performing a corresponding operation to the target cluster and the target component;
when the current event is a current-component-set event, according to current-component-set information in the current-component-set event, determining the target component and the target cluster; and
according to current-component-set-operation information in the current-component-set event, performing the corresponding operation to the target cluster and the target component.
